(19) United States
(12) Patent Application Publication
(10) Pub. No.: US 2013/0022937 A1
(43) Pub. Date: Jan. 24, 2013

(54) METHOD FOR MANUFACTURING A TEMPLATE FOR PROVIDING DENTAL IMPLANTS IN A JAW

(71) Applicants: Rene De Clerck, Tervuren (BE); Ali Tahmaseb, Schoten (BE)

(72) Inventors: Rene De Clerck, Tervuren (BE); Ali Tahmaseb, Schoten (BE)

(21) Appl. No.: 13/639,015

(22) PCT Filed: Apr. 4, 2011
(86) PCT No.: PCT/BE2011/000016

§ 371 Date: Oct. 2, 2012

(30) Foreign Application Priority Data
Apr. 2, 2010 (BE) BE 2010/0214

(51) Int. Cl. A61C 19/04; A61C 9/00

(52) U.S. Cl. 433/44

(57) ABSTRACT

The invention concerns a method for manufacturing a template with at least one opening to drill through so as to create an appropriate bore hole in the bone of a partially toothless lower or upper jaw so as to fix an implant in said bone. Hereto a mould plate with a means of reference is made which can be put in a fitting manner over teeth which are present in the jaw and a position for the corresponding bore hole is selected and determined in relation to said means of reference. An aligning plate is made, provided with fixing means which make it possible to mount the aligning plate on the mould plate. Said opening in the aligning plate for guiding a drill is provided in such a position that, when the aligning plate is mounted on said mould plate and the latter has been provided in a fitting manner on said teeth, the position of this opening makes it possible, when drilling through said opening, to create said bore hole in correspondence with the selected position.

The invention concerns a method for manufacturing a template with at least one opening to drill through so as to create an appropriate bore hole in the bone of a partially toothless lower or upper jaw so as to fix an implant in said bone.

Implants are usually provided in a jaw in order to anchor dental prostheses. Such prostheses may consist for example of a solitary false tooth which is fixed on a single implant or of a superstructure which extends over a major part of the jaw and on which several false teeth are provided. Also, such a superstructure is mounted on several implants, i.e. two, three, four or more implants.

The aim is now to provide a patient with a dental prosthesis in as little as treatment steps as possible. The implants are hereby immediately loaded, as they say, whereby a permanent dental prosthesis is mounted on these implants practically while the implants are being provided in the jaw. Such a method requires a thorough planning and a very high accuracy when providing the implants. Indeed, the planned position of the implants to be provided must correspond practically perfectly to the actual definite position of the implants after they have been provided in the jaw. For the dental prosthesis is made on the basis of the planned position of the implants before the latter are actually provided in the jaw.

In order to make this possible, use is made of a template according to the present state of the art to precisely drill bore holes in which the implants are to be fixed. However, many of the existing techniques are not patient-friendly or they are rather complex and do not provide sufficient guarantees as to obtaining the required accuracy.

Thus, the invention aims to provide a method for manufacturing a template which is practically free of any discomforts for the patient, whereby a template is obtained which makes it possible to provide the planned bore holes for implants in a jaw in a very accurate manner.

To this aim, according to the method of the invention, a mould plate is made which can be put in a precisely fitting manner over teeth which are present in the jaw and which is provided with at least a three-dimensional means of reference and positioning means. These positioning means may possibly be formed of said means of reference.

The position for the corresponding bore hole is selected and determined in relation to said means of reference when said mould plate has been put in a fitting manner over the teeth. This is done for example on the basis of a three-dimensional X-ray image made of the mould plate with the means of reference when the latter is placed on the jaw in the oral cavity.

Further, an aligning plate is made, provided with fixing means which make it possible to mount the aligning plate in a unique position with respect to said means of reference on the mould plate. In particular, the aligning plate is manufactured in such a way that the fixing means can be connected in a unique manner to said positioning means in order to mount the aligning plate on the mould plate.

The aforesaid opening in the aligning plate for guiding a drill is provided in such a position that, when the aligning plate is mounted on said mould plate and the latter has been provided in a fitting manner on said teeth, the position of this opening makes it possible, when drilling through said opening, to create said bore hole in correspondence with the selected position.

In particular, this opening is formed of a preferably cylindrical channel whose position and orientation are selected such that, taking into account the location of the fixing means, when the aligning plate has been mounted on said mould plate and the latter has been put in a fitting manner over the teeth, said bore hole can be created with the aimed position and orientation.

Thus, the template according to the invention is formed by fixing said aligning plate on said mould plate.

In order to drill said bore holes, the mould plate together with the aligning plate are placed in a fitting manner on the teeth of the jaw, after which the drilling takes place through the opening concerned. To this end, a drill or several drills with increasing diameters are guided through the opening or in other words through said channel during the drilling.

Once the bore hole has been made, the implant to be provided can possibly also be guided through said opening while screwing it down in the bore hole.

In an advantageous way, a three-dimensional image is made of the jaw together with the mould plate and said three-dimensional means of reference, in particular an X-ray image and for example an image obtained by means of a CT scan. On the basis of this image, the position for the corresponding bore hole is selected and determined in relation to said means of reference.

Preferably however, a physical model of the jaw is made, in particular a plaster model, and said mould plate is placed on this model, whereby provisional prosthetic teeth are placed on this mould plate. The latter can be done for example by means of what is called the lost-wax technique. The false teeth themselves can be made of a material which is clearly visible in an X-ray thereof, such as for example barium sulphate.

Next, an X-ray image is made of the jaw and of the mould plate placed in a fitting manner thereon with the provisional prosthetic teeth and said means of reference. In this X-ray image, obtained for example by means of a CT-scan, critical anatomical structures of the jaw such as nerve bundles as well as the means of reference are visible. Thus, on the basis of this image, a position and orientation for said bore hole are selected and determined in relation to the means of reference, taking into account any critical anatomical structures of the jaw.

The three-dimensional means of reference must allow for the three-dimensional position of the mould plate to be determined in a unique way in relation to the jaw. To this end, this means of reference can be made for example of several reference elements which are each fixed to said mould plate in separate positions.

Such reference elements consist for example of bushes with internal thread which are fixed on the mould plate by means of synthetic resin, glue, screwing, etc. When an X-ray image is made of the jaw with the mould plate, in an advantageous manner, a support provided with a marker made of a material which is highly contrasting in X-ray images will be fixed to the reference elements in order to determine the position of the latter. Such a support with a marker has been described for example in document WO 2005/084576.

If the mould plate has such reference elements, corresponding screw holes will be provided for example in the aligning plate in order to rigidly fix the latter to the mould plate with screws through the screw holes. These screw holes thus form fixing means which are connectable to said reference elements formed of bushes with internal thread. Such reference elements also form a three-dimensional positioning means then.

The means of reference may also be formed of one or several three-dimensional objects, such as for example one or several straight prisms.

In an interesting manner, in the aligning plate is then provided a recess whose shape corresponds to that of the means of reference, such that the aligning plate can be placed in a fitting manner over the means of reference on the mould plate. This recess then forms said fixing means, whereas the three-dimensional object concerned is also a positioning means. In particular, the aligning plate is then mounted on the mould plate by placing it in a fitting manner over the means of reference with said recess and by possibly fixing it to the latter by means of a screw, glue or the like.

When the jaw in which the implants are to be provided does not have sufficient teeth to put a mould plate over in a stable manner, an additional supporting point for the mould plate can be provided in the jaw by fixing an additional reference element to the jaw's bone, for example in the form of a screw protruding through the gums. Thus, the mould plate can also be connected in a fitting manner to the head of the screw or it can be fixed to the screw.

The mould plate can for example be made by providing a synthetic plate in the oral cavity. This plate is provided over the teeth which are still present in the jaw in which the implants need to be fixed and it is pressed over these teeth such that the synthetic material is plastically deformed and assumes the negative shape of at least the upper side of the teeth. This synthetic material is then made to harden, for example under the influence of UV light, such that a rigid whole is obtained which can be provided in a fitting manner on the teeth concerned of the jaw.

Naturally, the mould plate can also be made on the basis of a physical model of the jaw with the available teeth, such as for example a plaster model.

When manufacturing the mould plate, it is preferably made sure that the positions where an implant may need to be fixed are left free in the jaw. Thus, this mould plate will not form an obstacle for drilling the bore holes when the aligning plate is mounted on the mould plate and the latter has been provided in a fitting manner on the teeth concerned in the oral cavity.

The aligning plate is preferably made by means of what is called a “Rapid prototyping” technique such as, for example, milling, selective laser sintering or melting, stereolithography, 3D printing, etc.

In the given examples in the description above, the positioning means consist of said three-dimensional means of reference. Naturally, however, a mould plate can be provided with a three-dimensional means of reference as well as with positioning means. In such a case, the three-dimensional means of reference is formed for example of several radio-opaque balls which are fixed to the mould plate. The positioning means consist for example of a three-dimensional object then, such as a prism, which is also fixed to the mould plate, or of several separate elements which are either or not threaded and which are fixed in relation to the mould plate. The relative position of these positioning means is hereby determined precisely fitting in relation to the three-dimensional means of reference. Taking into account this relative position and the required position and orientation of the bore hole in relation to the three-dimensional means of reference, the aligning plate is subsequently manufactured. This aligning plate is provided with said fixing means which may connect in a unique manner to the positioning means concerned of said mould plate in order to fix the aligning plate to the latter. Said opening for guiding a drill to create a bore hole is also provided in the aligning plate on the basis of said relative position and the required position and orientation of the bore hole in relation to the three-dimensional means of reference.

In general we can say that the invention concerns a method for manufacturing a template comprising a mould plate and an aligning plate, whereby the aligning plate has at least one opening through which an appropriate bore hole can be drilled in the bone of a partially toothless lower or upper jaw so as to fix an implant in said bone. A mould plate is hereby made with a means of reference which can be provided in a fitting manner over teeth which are present in the jaw, and a position for the corresponding bore hole is selected and determined in relation to the means of reference. An aligning plate is made, comprising fixing means to mount the latter on the mould plate. Said opening in the aligning plate for guiding a drill is provided in such a position that, when the aligning plate is mounted on said mould plate and the latter is provided in a fitting manner on said teeth, the position of this opening will make it possible, when drilling through said opening, to create said bore hole in accordance with the selected position.

1. Method for manufacturing a template with at least one opening to drill through so as to create an appropriate bore hole in the bone of a partially toothless lower or upper jaw so as to fix an implant in said bone,
whereby
a mould plate is manufactured which can be provided in a unique and fitting manner over teeth which are present in the jaw;
this mould plate is provided with at least one three-dimensional means of reference and positioning means; the position for the corresponding bore hole is selected and determined in relation to said means of reference when said mould plate has been provided in a fitting manner over said teeth;
an aligning plate is manufactured which is provided with fixing means which are connectable to said positioning means so as to mount the aligning plate on the mould plate, whereby these fixing means make it possible to mount the aligning plate in a unique manner in relation to the means of reference on said mould plate;
the opening in the aligning plate is provided in such a position that, when the aligning plate is mounted on said mould plate and the latter has been placed in a fitting manner on said teeth, the position of this opening will make it possible, when drilling through this opening, to create said bore hole in accordance with the selected position;
said aligning plate is fixed on said mould plate so as to form said template.

2. Method according to claim 1, whereby said positioning means are formed of said three-dimensional means of reference.

3. Method according to claim 1, whereby a coordinate system is associated with said three-dimensional means of reference and the position of said bore hole is defined in this coordinate system, whereby a corresponding position for said opening is determined in this coordinate system, and whereby said aligning plate is manufactured with this opening, such that when this aligning plate is mounted on said mould plate, the opening of the aligning plate corresponds to the opening as determined in said coordinate system.

4. Method according to claim 1, whereby a three-dimensional X-ray image is made of the jaw together with the mould plate and said three-dimensional means of reference, whereby on the basis of this image, the position of the corresponding bore hole is selected and determined in relation to said means of reference.

5. Method according to claim 1, whereby a plaster model is made of the jaw and said mould plate is put on this model, whereby provisional prosthetic teeth are provided on this mould plate, whereby an X-ray image is subsequently made of the jaw and the mould plate with the provisional prosthetic teeth and said means of reference when the latter has been fitted on said teeth in the oral cavity, and whereby on the basis of this image, a position for said bore hole is selected and determined in relation to said means of reference, taking into account any critical anatomical structures of the jaw such as nerve bundles.

6. Method according to claim 1, whereby said three-dimensional means of reference consists of several reference elements which are each fixed to said mould plate in separate positions.

7. Method according to claim 1, whereby a three-dimensional object is selected as said three-dimensional means of reference.

8. Method according to claim 7, whereby a recess is provided in said aligning plate whose shape corresponds to that of said means of reference, such that the aligning plate is mounted on the mould plate by placing it in a fitting manner over the means of reference with said recess.

9. Method according to claim 1, whereby said mould plate is manufactured such that it leaves the selected position for said bore hole free.

10. Method according to claim 1, whereby said mould plate has means to be fixed on a reference element provided in said jaw.

11. Method according to claim 1, whereby said aligning plate is manufactured by means of a “Rapid prototyping” technique on the basis of a three-dimensional digital image of said mould plate with said means of reference when the latter is provided on the jaw in the oral cavity, whereby the orientation and position of said bore hole is determined in relation to said means of reference, taking into account any critical anatomical structures of the jaw.
